(19) United States
(12) Patent Application Publication
(10) Pub. No.: US 2007/0033812 A1
(43) Pub. Date: Feb. 15, 2007

(54) Cutting blade for cutting rod-like members and cutting machine to which the cutting blade is mounted

(75) Inventor: Kiyoshi Kimura, Fujisawa-shi (JP)

Correspondence Address: OLIFF & BERRIDGE, PLC, P.O. BOX 19928, ALEXANDRIA, VA, 22320, US

(73) Assignee: KABUSHIKI KAISHA OGURA, Ebina-shi (JP)

(21) Appl. No.: 11/497,354

(22) Filed: Aug. 2, 2006

(30) Foreign Application Priority Data
Aug. 10, 2005 (JP) 2005-231887

(51) Int. Cl. B26B 13/00; B26B 15/00

(52) U.S. Cl. 30/173

(57) ABSTRACT

A cutting portion 6 is formed at a distal end of each of a pair of cutting blades 1. A projecting portion 7 is provided at a position spaced away from the cutting portion 6 along the axial direction of a rod-like member to be cut, wherein when the cutting portions 6 abut each other, the projecting portions bite some portion of the rod-like member to be cut. Accordingly, the cut piece can be held and thus cannot fly outward upon the cutting operation

### BACKGROUND OF THE INVENTION

1. Field of the Invention

The present invention relates to a cutting blade for cutting rod-like members and a cutting machine to which the cutting blade is mounted, and particularly to a cutting blade for cutting reinforcing rods implanted in concrete and a cutting machine thereof.

2. Background Art

For a cutting blade adapted to cut reinforcing rods implanted in concrete such that there will be no remaining rod portions projecting from the concrete face after the cutting operation and the face of each rod cut by the blade will be substantially flush with the concrete face, it should be configured to have a blade which will take a position parallel to the concrete face upon the cutting operation. Therefore, such a cutting blade comprises a horizontal face, an inclined face defining an angle relative to the horizontal face, and a cutting portion formed at a distal end of the inclined face, wherein a reinforcing rod is cut by placing a pair of such cutting blades in positions opposite to each other across the rod and then moving them closer until their cutting portions abut each other.

Since such cutting blades cut a hard material such as reinforcing rods and their cutting portions abut each other upon cutting operation, significantly large force effects on the cutting blades upon the cutting operation. Accordingly, the angle of the inclined face should be greater as compared to usual sliding cutting blades or those for cutting synthetic resinous members.

However, as the inclination angle of the cutting portion is increased, upon the cutting operation, a component force effecting in the axial direction of a rod-like member (reinforcing rod) to be cut becomes larger, and in the moment the rod-like member is cut, the cut piece tends to go flying away in the axial direction due to the larger component force. The distance that the cut piece can fly may be in a range of several meters to even several tens of meters. Therefore, this is risky for workers or other surrounding persons of interest, and sometimes, a ceiling, walls or the like may be damaged.

To address this problem, in the conventional cutting machines, a measure has been taken in which an associated protective member is mounted to cover the cutting blade, or otherwise an elastic member formed of an urethane rubber is provided near the cutting blade to hold the cut piece (Japanese Patent Publication No. 7-41462).

However, the protective member which is specially mounted to the cutting machine will interfere with the cutting work, thus lowering the working efficiency. In addition, such a protective member tends to cause a great noise of the impact due to the collision of the cut piece, and is difficult to use if a portion of each rod-like member projecting from the concrete face is significantly long.

Additionally, the structure provided with the aforementioned urethane rubber is difficult to use for a long period of time because the urethane rubber tends to be degraded and damaged over time. This structure is also difficult to accommodate to securely hold the cut piece in response to the change of the diameter of the rod-like member to be cut.

The present invention was made in light of the aforementioned problems. It is therefore an object of this invention to provide a cutting blade which has a simple structure and can securely hold a cut piece of a rod-like member, and a cutting machine to which the cutting blade is mounted.

### SUMMARY OF THE INVENTION

To achieve the above object, the invention set forth in claim 1 features a pair of cutting blades for cutting a rod-like member having cutting portions each formed at a distal end of an inclined face inclining to define an angle θ relative to the horizontal face, the cutting portions being configured to move up to a position where they abut each other, characterized in that: in each of the inclined faces of the pair of cutting blades, a projecting portion is provided at a position spaced away from the cutting portion along the axial direction of the rod-like member to be cut, and that when the cutting portions abut each other, the projecting portions bite some portion of the rod-like member to be cut.

The invention set forth in claim 2 features that the pair of projecting portions are provided such that, when the pair of cutting portions abut each other, the pair of projecting portions take opposing positions to define a predetermined interval therebetween.

The invention set forth in claim 3 features that the projecting portions are provided in large numbers with an interval provided between each opposing pair of the projecting portions along the axial direction of the rod-like member to be cut.

The invention set forth in claim 4 features that the plurality of projecting portions are provided such that the interval of each opposing pair of the projecting portions becomes larger as they are spaced farther away from the cutting portions along the axial direction of the rod-like member to be cut.

The invention set forth in claim 5 features that the angle θ of the inclined face is in the range of 20 to 40 degrees.

The invention set forth in claim 6 features that the projecting portions are formed integrally with the cutting portions.

The invention set forth in claim 7 features that each cutting blade comprises a generally trapezoidal block having a first inclined face defining an angle (θ+α) relative to the horizontal face, wherein a lower portion of the first inclined face of the block is shaved off so as to form a cutting portion having a second inclined face defining an angle θ relative to the horizontal face in the shaved off portion and form a projecting portion in a middle portion of the first inclined face.

The invention set forth in claim 8 features that the size of the shaved off portion in the first inclined face is determined depending on the diameter of the rod-like member to be cut.

The invention set forth in claim 9 features a cutting machine for cutting a rod-like member, wherein a pair of cutting blades are mounted to distal ends of a pair of arms configured to reciprocate in a direction such that they get closer to each other, wherein the pair of cutting blades have cutting portions each formed at a distal end of an inclined face inclining to define an angle θ relative to the horizontal face, and wherein in each of the inclined faces of the pair of cutting blades, a projecting portion is provided at a position spaced away from the cutting portion along the axial direction of the rod-like member to be cut, and wherein when the cutting portions abut each other, the projecting portions bite some portion of the rod-like member to be cut.

The invention set forth in claim 10 features that the pair of arms are driven by a potable hydraulic actuator apparatus.

According to the invention set forth in claim 1, since the projecting portions bite some portion of the cut rod-like member when the rod-like member is cut by the cutting portions abutting each other, the cut piece can be held by the projecting portions, thus cannot fly outward.

According to the invention set forth in claim 2, since the pair of projecting portions are provided such that, when the pair of cutting portions abut each other, the pair of projecting portions take opposing positions to define a predetermined interval therebetween, they can bite the rod-like member corresponding to its diameter up to a suitable depth, thus securely holding the cut piece.

According to the invention set forth in claim 3, since the projecting portions are provided in large numbers with an interval provided between each opposing pair of the projecting portions along the axial direction of the rod-like member to be cut, even when the diameter of the rod-like member to be cut changes, the projecting portions being located at positions corresponding to the diameter can adequately bite the rod-like member, thus securely holding the cut piece.

According to the invention set forth in claim 4, since the plurality of projecting portions are provided such that the interval of each opposing pair of the projecting portions becomes larger as they are spaced farther away from the cutting portions along the axial direction of the rod-like member to be cut, when the diameter of the rod-like member to be cut is small, the cut piece can be held by the projecting portions located nearer to the cutting portions, while when the diameter of the rod-like member to be cut is large, the cut piece can be held by the projecting portions located farther from the cutting portions, thus, in either case, securely holding the cut piece.

According to the invention set forth in claim 5, since the angle θ of the inclined face is in the range of 20 to 40 degrees, the mechanical strength of the cutting blade can be increased, thus securely cutting a hard quality rod-like member such as reinforcing rods.

According to the invention set forth in claim 6, since the projecting portions are formed integrally with the cutting portions, a cutting blade with a simple structure and high mechanical strength can be obtained.

According to the invention set forth in claim 7, each cutting blade comprises a generally trapezoidal block having a first inclined face defining an angle (θ+α) relative to the horizontal face, wherein a lower portion of the first inclined face of the block is shaved off so as to form a cutting portion having a second inclined face defining an angle θ relative to the horizontal face in the shaved off portion and form a projecting portion in a middle portion of the first inclined face, and wherein some portion of the rod-like member above the cutting portions can enter the space of the shaved off portion upon the cutting operation to be interposed between the cutting portions and the projecting portions, thus securely and firmly preventing the cut piece from flying upward.

According to the invention set forth in claim 8, since the size of the shaved off portion in the first inclined face is determined depending on the diameter of the rod-like member to be cut, an optimum projecting portion can be obtained corresponding to the diameter of the rod-like member.

According to the invention set forth in claim 9, since the pair of cutting blades are mounted to distal ends of the pair of arms configured to reciprocate in a direction such that they get closer to each other, the cut piece cannot fly outward upon cutting the rod-like member, thus providing a significantly safe cutting work.

According to the invention set forth in claim 10, since the pair of arms are driven by a potable hydraulic actuator apparatus, the cutting operation of rod-like members can be easily performed on a working site.

### BRIEF DESCRIPTION OF THE DRAWINGS

FIG. 1 is a perspective view showing a cutting blade according to Example 1 of the present invention.

FIG. 2 is a side cross-section showing a structure of the cutting blade shown in FIG. 1.

FIG. 3 is an illustration showing one example in which a pair of cutting blades shown in FIG. 1 are placed in positions opposite to each other across a rod-like member.

FIG. 4 is an illustration showing a state where the rod-like member is fully cut using the cutting blades shown in FIG. 1.

FIG. 5 is a perspective view showing a cutting blade according to Example 2 of the present invention.

FIG. 6 is a perspective view showing one example of a cutting machine to which are mounted the cutting blades of Example 2 of the present invention.

FIG. 7 is a partly cross-sectioned view showing a portion around the cutting blades mounted to the cutting machine shown in FIG. 6.

FIG. 8 is a perspective view showing a state where the cutting blade according to Example 2 of the present invention is mounted to an arm of the cutting machine.

FIG. 9 is a partly front view showing a state where a rod-like member is cut by the cutting machine shown in FIG. 6.

FIG. 10 is a side view of a cutting blade according to Example 3 of the present invention.

### DETAILED DESCRIPTION OF THE INVENTION

### EXAMPLES

### Example 1

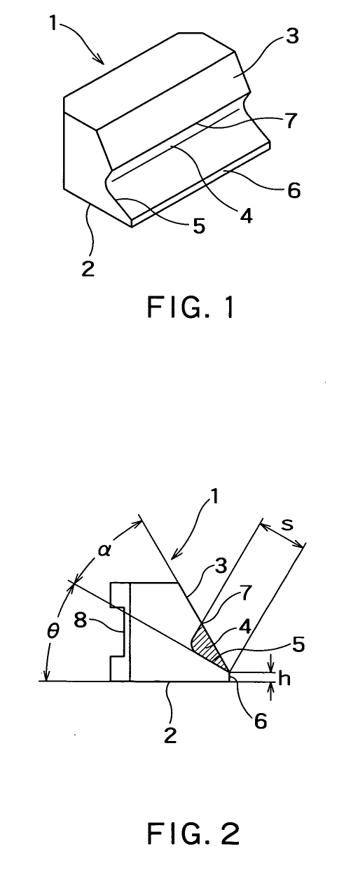

FIGS. 1 to 4 are provided herein to explain Example 1 of the present invention. In FIG. 1, a cutting blade according to Example 1 is shown. In FIG. 2, a structure of the cutting blade is illustrated in cross-section.

The cutting blade 1 comprises a generally trapezoidal block having a horizontal face 2 and a first inclined face 3 defining an angle (θ+α) relative to the horizontal face 2. An indentation 4 is formed by shaving off a lower portion of the first inclined face 3.

In the indentation 4, a second inclined face 5 is formed with an angle θ relative to the horizontal face 2, and a cutting portion 6 is formed at a distal end of the second inclined face 5. The cutting portion 6 has a predetermined thickness h in order to withstand the impact upon the cutting operation. A projecting portion 7 is formed at an intersection of the indentation 4 and the first inclined face 3.

A recess 8 located behind the cutting blade 1 is adapted to mount the cutting blade 1 to a cutting machine.

While the angle θ depends on the quality, diameter or the like factor of the rod-like member to be cut, it is preferred that this angle is in the range of 20 to 40 degrees when the cutting blade is used for cutting reinforcing rods implanted in concrete. In the present example, the angle of 30 degrees is employed as the angle θ. Again, the angle α depends on the quality, diameter or the like factor of the rod-like member to be cut, and the angle of 30 degrees is employed as the angle α in the present invention.

The amount of shaving off the first inclined face 3, i.e., the largeness of the indentation 4 to be formed by the shaving off process depends on the diameter of a rod-like member to be cut. Namely, when the diameter of the rod-like member is larger, the indentation 4 becomes greater, while when the diameter of the rod-like member is smaller, the indentation 4 becomes smaller.

Now referring to FIG. 2, when the distances from the cutting portion 6 to the projecting portion 7 is larger, the indentation 4 becomes greater, and the interval between the projecting portions 7 positioned opposite to each other also becomes larger. This aspect is suitable for holding a rod-like member having a relatively larger diameter. Contrary, as the distances becomes smaller, the indentation 4 will be smaller, and the interval between the projecting portions 7 positioned opposite to each other will also be narrowed. This aspect is suitable for holding a rod-like member having a relatively smaller diameter.

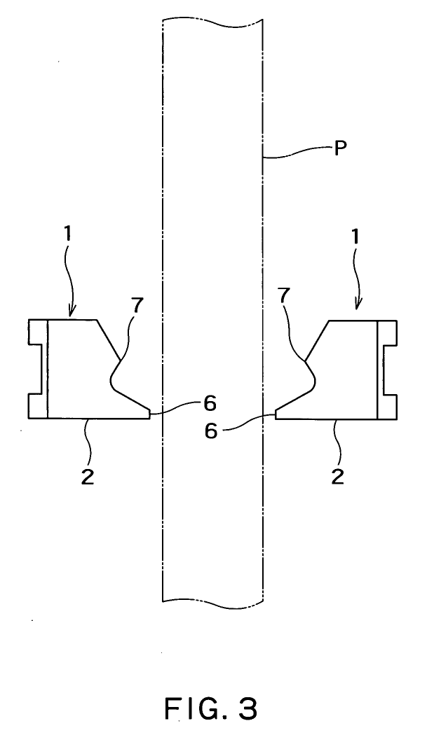

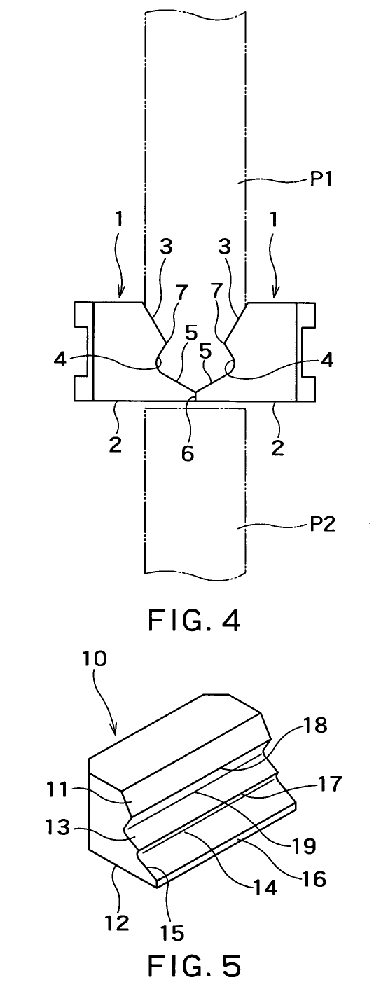

Next, operation of the present example will be described with reference to FIGS. 3 and 4.

FIG. 3 shows a state where a pair of cutting blades 1 according to the present example are placed in positions opposite to each other across a rod-like member P. In this state, the horizontal face 2 of the cutting blade 1 is positioned generally along the face of concrete (not shown).

FIG. 4 shows a state where the rod-like member P is fully cut by the pair of cutting blades 1 according to the present example. Namely, the cutting portions 6 of the pair of cutting blades 1 have already abutted each other, and thus the rod-like member P has been separated into a cut piece P1 and a portion P2 remaining in the concrete. In this case, the projecting portions 7 located above the cutting portions 6 bite some portion of the cut piece P1, and other portion of the cut piece P1 get into the indentations 4, respectively.

As a result, the cut piece P1 is in a state of being securely held by the cutting portions 6 and projecting portions 7 of the cutting blades 1. Thus, regardless of the component force effecting upward upon the cutting operation, the cut piece P1 cannot fly upward.

FIG. 5 is an illustration showing a cutting blade according to Example 2 of the present invention.

In FIG. 5, a cutting blade 10 is shown to be provided with two projecting portions 17, 18 being arranged along the axial direction of a rod-like member to be cut and having an interval therebetween. The cutting blade 10 according to Example 2 includes two indentations 14, 19 which are formed, with an interval along the axial direction, in a first inclined face 11 of a generally trapezoidal block, wherein a second inclined face 15 defining an inclination angle θ relative to the horizontal face 12 is formed in the lower indentation 14 which is located nearer to the horizontal face 12, and a third inclined face 13 is provided in the upper indentation 19.

A cutting portion 16 is formed at a distal end of the second inclined face 15, and a first projecting portion 17 is formed between the two indentations 14, 19. In addition, a second projecting portion 18 is formed at an intersection of the upper indentation 19 and the first inclined face 11.

According to this example, when a pair of cutting blades 10 are placed in positions opposite to each other across a rod-like member to be cut, the interval between the first projecting portions 17 will thus be smaller than the interval between the second projecting portions.

Accordingly, in this example, when cutting a smaller diameter rod-like member, a cut piece to be formed will be held by the first projecting portions 17 which are located nearer to the cutting portions 16, while when cutting a larger diameter rod-like member, a cut piece to be formed will be held by the second projecting portions 18 which are located farther away from the cutting portions 16.

Namely, in the case of cutting a rod-like member, the force to be effected becomes greater as the diameter of a rod-like member to be cut is increased, so that it will be difficult to securely hold the cut piece only by the first projecting portions 17 located nearer to the cutting portions 16. Thus, it will be required for the cut piece to be held by the second projecting portions 18 which are farther away from the cutting portions 16. Contrary, in the case of cutting a smaller diameter rod-like member, the force to be effected also becomes smaller, so that the cut piece can be securely held even only by the first projecting portions 17.

In such a way, according to the cutting blade 10 of this example, even in the case of cutting rod-like members having different diameters using the same cutting blade 10, any of the cut pieces can be held securely.

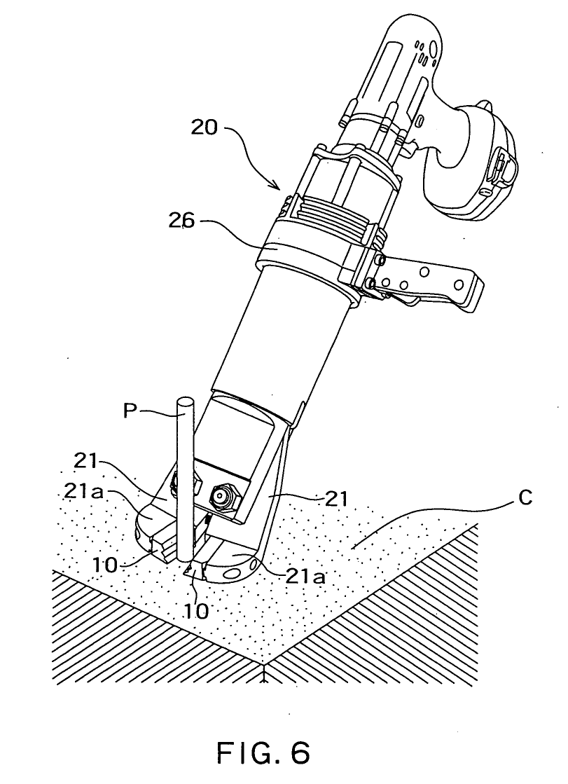

FIGS. 6 to 9 illustrate one example of a cutting machine for cutting rod-like members, to which the cutting blades 10 of the Example 2 are mounted.

FIG. 6 is a perspective view showing the whole body of the cutting machine 20 for cutting rod-like members, in which the cutting blade 10 of Example 2 are mounted to a pair of arms 21 which are driven by a publicly known potable hydraulic actuator apparatus 26, respectively.

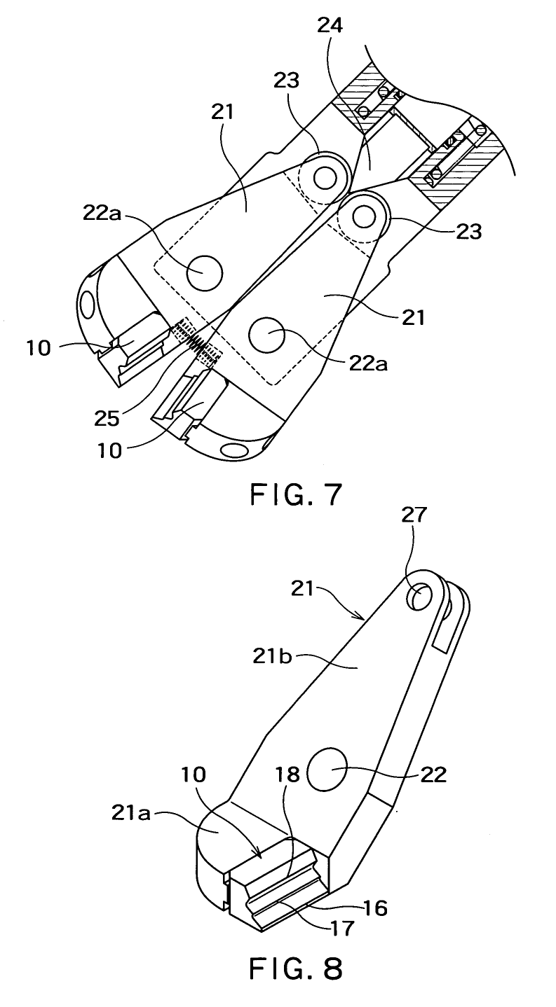

FIGS. 7 and 8 are partial cross-sections showing a mounted state of the cutting blades 10, respectively. The pair of arms 21, as shown in FIG. 8, each comprises a horizontal portion 21a and an inclined portion 21b. The cutting blades 10 are mounted to opposing places of the horizontal portions 21a, respectively. In each of the inclined portions 21b, an opening through which a swaying shaft is inserted and an aperture 27 in which a roller 23 is mounted are provided.

The pair of arms 21 are attached, as shown in FIG. 7, to a distal end of the potable hydraulic actuator apparatus 26 such that the arms 21 can sway about each swaying shaft 22a to get closer to each other. The rollers 23 are rotatably mounted in the apertures 27 provided at one ends of the inclined portions 21b, respectively. The swaying operation of the arms 21 is effected by inserting a piston 24, which is reciprocally driven by the potable hydraulic actuator apparatus 26, between the pair of rollers 23.

In FIG. 7, reference numeral 25 denotes a return spring which serves to automatically return the arms 21 to their opened positions.

When cutting a rod-like member (reinforcing rod) P projecting from a concrete face C using the cutting machine 20 having such a structure, the horizontal portions 21a of the arms 21 are first placed along the concrete face C, and the horizontal faces 12 of the cutting blades 10 are then positioned possibly near to the concrete face C with the rod-like member P inserted therebetween.

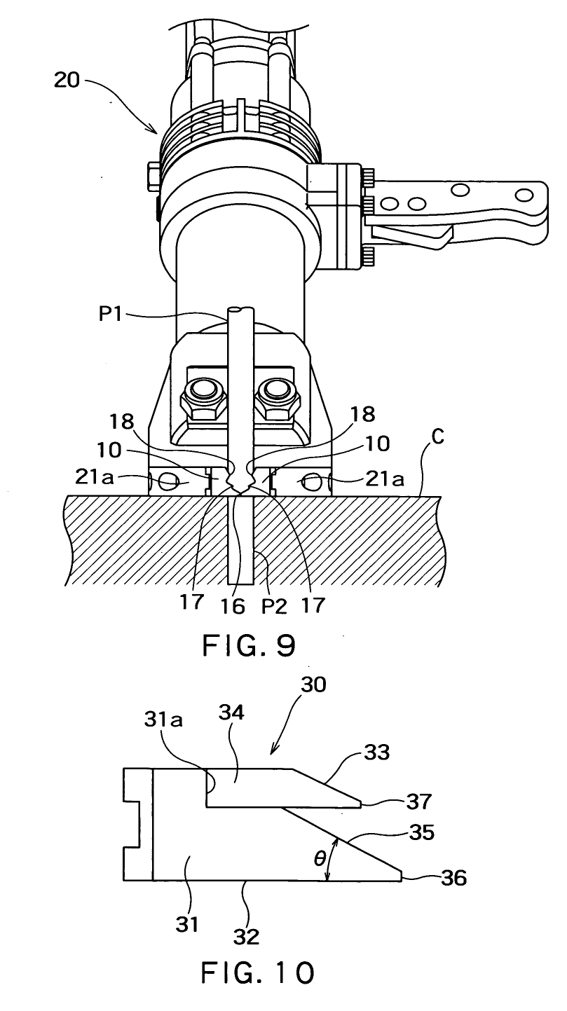

Subsequently, by actuating the potable hydraulic actuator apparatus 26 to sway the pair of arms 21 to get closer to each other, the rod-like member P is cut by the pair of cutting blades 10. FIG. 9 shows a point of time the cutting operation is ended. As shown in FIG. 9, the rod-like member P is separated into a cut piece P1 and a remaining portion P2 by the pair of cutting portions 16 abutting each other.

At this time, the cut piece P1 is held by the first projecting portions 17 and the second projecting portions 18, so that the cut piece P1 cannot fly upward. After the cutting operation is ended, by opening again the pair of arms 21 due to actuation of the hydraulic actuator apparatus, the cut piece P1 can be removed from the cutting blades 10.

FIG. 10 is a side view of a cutting blade according to Example 3 of the present invention.

A cutting blade 30 according to this example is constructed such that a holding block 34 in which a projecting portion 37 is formed at a distal end of an inclined face 33 is attached onto a cutting block 31 in which a cutting portions 36 is formed at a distal end of an inclined face 35.

Namely, a step portion with a vertical wall 31a is formed above the inclined face 35 defining an angle θ relative to a horizontal face 32, and the holding block 34 is attached onto the step.

According to this example, by changing the size of the holding block 34, the position of the projecting portion 37 relative to the cutting portion 36 can be adjusted to an optimum position. For example, when cutting a larger diameter rod-like member, the holding block 34 may be adjusted to a smaller shape or size such that the interval of the projecting portions 37 placed in positions opposite to each other becomes adequately large, while when cutting a smaller-diameter rod-like member, the holding block 34 may be adjusted to a larger shape or size such that the interval of the projecting portions 37 placed in positions opposite to each other becomes properly small.

As with the case of the previous examples, the cutting blade 30 of this example also enables to hold the cut piece to be formed upon the cutting operation and prevent the cut piece from flying outward.

While in the previous examples the cases where one or two projecting portions are provided were described, three or more projecting portions may be provided.

As stated above, according to the present invention, a benefit can be obtained, which when a rod-like member is cut by mutual abutment of the cutting portions of the cutting blades, since the projecting portions bite some portion of the cut rod-like member, the cut piece is held by the projecting portions, thus cannot fly outward.

The present invention can be applied to such a cutting blade that a cutting portion for cutting a rod-like member is formed at a distal end of an inclined face, and a cut piece may tend to fly outward due to a component force of the cutting force generated upon the cutting operation, as well as applied to a cutting machine to which such a cutting blade is mounted. In particular, when applied to a cutting machine for cutting reinforcing rods implanted in concrete such that there will be no remaining rod portions projecting from the concrete face after the cutting operation, this invention can provide a significantly excellent effect.

1. A pair of cutting blades for cutting a rod-like member, each cutting blade comprising: a horizontal face; an inclined face inclining to define an angle θ relative to the horizontal face; a cutting portion formed at a distal end of the inclined face; and a projecting portion provided in the inclined face at a position spaced away from the cutting portion along the axial direction of the rod-like member to be cut and in an orientation orthogonal to the axial direction of the rod-like member, wherein when the cutting portion abuts the opposing cutting portion, the projecting portions bite some portion of the rod-like member to be cut.

2. The pair of cutting blades for cutting a rod-like member according to claim 1, wherein the pair of projecting portions are provided such that, when the pair of cutting portions abut each other, the pair of projecting portions take opposing positions to define a predetermined interval therebetween.

3. The pair of cutting blades for cutting a rod-like member according to claim 1, wherein the projecting portions are provided in large numbers with an interval provided between each opposing pair of the projecting portions along the axial direction of the rod-like member to be cut.

4. The pair of cutting blades for cutting a rod-like member according to claim 3, wherein the plurality of projecting portions are provided such that the interval of each opposing pair of the projecting portions becomes larger as they are spaced farther away from the cutting portions along the axial direction of the rod-like member to be cut.

5. The pair of cutting blades for cutting a rod-like member according to claim 1, wherein the angle θ of the inclined face is in the range of 20 to 40 degrees.

6. The pair of cutting blades for cutting a rod-like member according to claim 1, wherein the projecting portions are formed integrally with the cutting portions.

7. The pair of cutting blades for cutting a rod-like member according to claim 6, wherein each cutting blade comprises a generally trapezoidal block having a first inclined face defining an angle (θ+α) relative to the horizontal face, and wherein a lower portion of the first inclined face of the block is shaved off so as to form a cutting portion having a second inclined face defining an angle θ relative to the horizontal face in the shaved off portion and form a projecting portion in a middle portion of the first inclined face.

8. The pair of cutting blades for cutting a rod-like member according to claim 7, wherein the size of the shaved off portion is determined depending on the diameter of the rod-like member to be cut.

9. A cutting machine for cutting a rod-like member, wherein the cutting blades according to claim 1 are mounted to distal ends of a pair of arms configured to reciprocate in a direction such that they get closer to each other.

10. The cutting machine for cutting a rod-like member according to claim 9, wherein the pair of arms are driven by a potable hydraulic actuator apparatus.
